(19) United States
(12) Patent Application Publication
(10) Pub. No.: US 2009/0161637 A1
(43) Pub. Date: Jun. 25, 2009

(54) COMMUNICATION APPARATUS AND METHOD IN WIRELESS SENSOR NETWORK

(75) Inventors: Jae Hong RUY, Daejeon-city (KR); Jong suk CHAE, Daejeon-city (KR); Cheol Sig PYO, Daejeon-city (KR); Bong Soo KIM, Daejeon-city (KR); Dong-Won KIM, Daejeon-city (KR); Mihee YOON, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-City (KR)

(21) Appl. No.: 12/268,695

(22) Filed: Nov. 11, 2008

(30) Foreign Application Priority Data
Dec. 17, 2007 (KR) 10-2007-0132709

(51) Int. Cl. H04W 72/00

(52) U.S. Cl. 370/336

(57) ABSTRACT

Provided are a communication method and apparatus of a wireless sensor network which uses at least one channel and has a tree structure. The method includes: generating windows, where a beacon interval is divided, according to each channel; selecting a window, which is not assigned to nodes that exist within a predetermined range from a certain node, from among the generated windows; and the certain node communicating with a child node of the certain node by using a channel to which the selected window belongs during a time corresponding to the selected window.

### CROSS-REFERENCE TO RELATED PATENT APPLICATION

This application claims the benefit of Korean Patent Application No. 10-2007-0132709, filed on Dec. 17, 2007, in the Korean Intellectual Property Office, the disclosure of which is incorporated herein in its entirety by reference.

### BACKGROUND OF THE INVENTION

1. Field of the Invention

The present invention relates to a wireless sensor network, and more particularly, to a scheduling method for preventing a collision while transmitting beacons.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking Technology].

2. Description of the Related Art

For a conventional sensor network, such as one employing the IEEE802.15.4 ZigBee standard, to reduce power consumption through a low duty cycle which is obtained by introducing an active period and a standby period, and to arrange sensor nodes scattered in a relatively wide area in a sensor network, a cluster tree or mesh structure should be used instead of a star topology structure.

For the low duty cycle, the conventional sensor network should be in a beacon enable mode in the IEEE802.15.4 ZigBee standard. Here, both synchronization and scalability should be satisfied.

However, no research has been conducted into how to build a cluster tree topology structure and how to assign and manage synchronization and schedule between clusters.

A network of a cluster tree model is formed of a plurality of coordinators (also called ZigBee routers), and each coordinator generates periodical beacon frames, and synchronizes nodes of an adjacent neighbor (a cluster) through the beacon frame.

In this case, when the periodical beacon frames are optionally transmitted instead of following a specific schedule, the beacon frames may collide with each other or with a data frame. When the beacon frames collide, a node, which periodically receives a beacon frame, can no longer coordinate and synchronize the beacon frame. Accordingly, communication is impossible in a network.

There are three reasons that the beacon frames collide. First, a direct beacon frame collision occurs when at least two coordinators exist in a mutual wireless transmission range (direct neighbors or a parent-to-child relationship) and transmit beacon frames at the almost same time. Second, an indirect beacon frame collision occurs when at least two coordinators do not exist in a mutual wireless transmission range (indirect neighbors), but almost simultaneously transmit beacon frames in an overlapping wireless transmission range. Third, a collision between a data frame and a beacon frame occurs when the beacon frame is transmitted in an active period of a neighboring cluster.

Accordingly, two basic methods for avoiding a beacon frame collision are studied in research on improving the IEEE 802.15.2 standard. A first method is a beacon-only period method, where a preparation period exists in the beginning of each superframe for beacon frame transmission. A second method is a time division method, where a beacon frame of a certain cluster is transmitted during an inactive period of other clusters.

However, there is no mention about how to realize these methods and specifically, a method raised in TG 15.4b is not applied in the IEEE 802.15.4b 2006 standard.

Research into increasing process capacity with low power consumption by using a multi-channel is being performed, but there is no synchronization scheduling method for multi-channel assignment and beacon collision prevention, or research that satisfies scalability.

### SUMMARY OF THE INVENTION

The present invention provides a scheduling method for effective multi-channel assignment and beacon collision prevention in a wireless sensor network.

According to an aspect of the present invention, there is provided a communication method of a wireless sensor network, which uses at least one channel and has a tree structure, the method including: generating windows which a beacon interval is divided into, for each of the at least one channel; selecting a window, that is not assigned to nodes that exist within a predetermined range from a certain node, from among the generated windows; and the certain node communicating with a child node of the certain node by using a channel to which the selected window belongs during a time corresponding to the selected window.

According to another aspect of the present invention, there is provided a communication method in a gateway of a wireless sensor network, which uses at least one channel and has a tree structure, the communication method including: generating windows which a beacon interval is divided into, for each of the at least one channel; and assigning each of a part of or all of the generated windows to a child node, and communicating with the child node assigned with each window by using a channel to which each window belongs during a time corresponding to each assigned window.

According to another aspect of the present invention, there is provided a communication apparatus of a wireless sensor network, which uses at least one channel and has a tree structure, the communication apparatus including: a window generator, which generates windows which a beacon interval is divided into, for each of the at least one channel; a window selector, which selects a window, which is not assigned to nodes that exist within a predetermined range from a certain node, from among the generated windows; and a communicator, through which the certain node communicates with a child node of the certain node by using a channel to which the selected window belongs during a time corresponding to the selected window.

According to another aspect of the present invention, there is provided a gateway of a wireless sensor network, which uses at least one channel and has a tree structure, the gateway including: a window generator, which generates windows which a beacon interval is divided into, for each of the at least one channel; and a communicator, which assigns each of a part of or all of the generated windows to a child node, and communicates with the child node assigned with each window by using a channel to which each window belongs during time corresponding to each assigned window.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating frame and beacon structures according to an embodiment of the present invention;

FIG. 2 is a conceptual diagram illustrating a method of generating windows according to an embodiment of the present invention;

FIG. 3 is a conceptual diagram illustrating a method of generating windows according to another embodiment of the present invention;

FIG. 4 is a conceptual diagram illustrating a method of generating windows according to another embodiment of the present invention;

FIG. 5 is a flowchart illustrating a joining process of a node according to an embodiment of the present invention;

FIG. 6 is a conceptual diagram illustrating a window selecting algorithm in a single channel according to an embodiment of the present invention;

FIGS. 7A and 7B are a flowchart illustrating processes of constructing a cluster tree network in a single channel according to an embodiment of the present invention;

FIGS. 8A and 8B are a flowchart illustrating a process of constructing a cluster tree network in a multi channel according to an embodiment of the present invention;

FIG. 9 is a conceptual diagram illustrating a method of assigning a window in a bridge coordinator according to an embodiment of the present invention; and

FIG. 10 is a conceptual diagram illustrating a method of assigning a window in a bridge coordinator according to another embodiment of the present invention.

### DETAILED DESCRIPTION OF THE INVENTION

The present invention will now be described more fully with reference to the accompanying drawings, in which exemplary embodiments of the invention are shown.

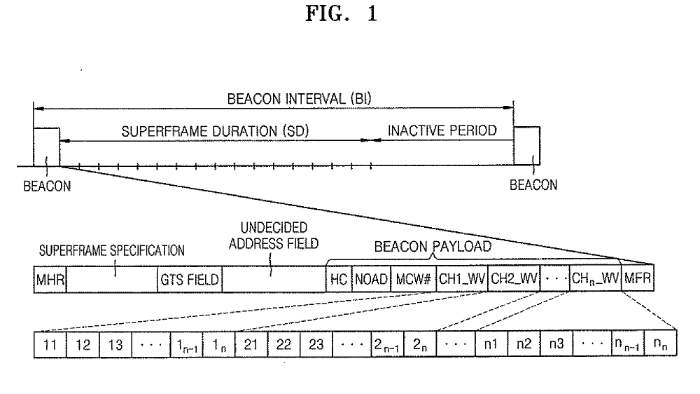

FIG. 1 is a diagram illustrating frame and beacon structures according to an embodiment of the present invention.

Referring to FIG. 1, the frame structure basically conforms to the IEEE 802.15.4 ZigBee standard. However in the beacon structure, a new definition using a payload field that can be defined and used by a user is added.

HC denotes a hop count from a piconet coordinator (PNC) or a gateway. The depth of a tree structure can be obtained from the HC, and thus a parent-child relationship can be obtained.

NOAD denotes the number of associated devices. The NOAD is information used in permission control in order to guarantee load balance and cluster performance when devices participate in communication.

CH1_WV through CHn_WV denote multi channel window vectors. Each of CH1_WV through CHn_WV shows occupancy of each window in a channel when n multi channels are used. The length of a vector is determined based on the number of channels (1≦k≦n) and the number of windows (1≦j≦m). Each bit is assigned with an address which is a pair of a channel and window. A bit corresponding to an unoccupied address is indicated as 0, and a bit (MCW#) corresponding to a channel and window which a node transmitting the beacon has control power over and a bit corresponding to a channel and window detected as being occupied by an adjacent node, i.e. a node that exists in a domain where a wireless signal of the node can directly reach, are indicated as 1. The MCW# can be recognized by other nodes by observing a beacon.

A concept of the window used in the present invention will now be described.

When all clusters use the same beacon order (BO) values and superframe order (SO) values, a beacon interval (BI) and superframe duration (SD) satisfy the following equations.

BI=aBaseSuperframeDuration*2^{BO}

SD=aBaseSuperframeDuration*2^{SO}

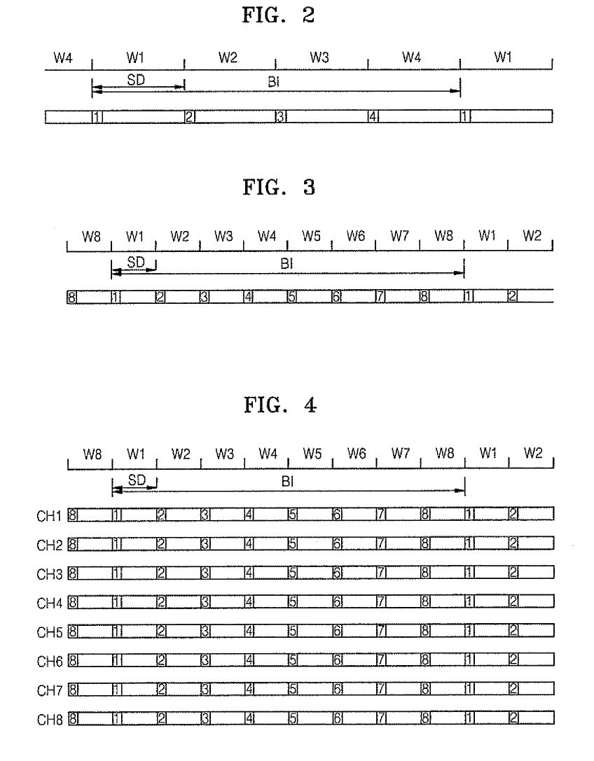

FIG. 2 is a conceptual diagram illustrating a method of generating windows according to an embodiment of the present invention.

Referring to FIG. 2, when only one channel is used, BO=6, and SO=4, windows are generated so that 4 SDs can be scheduled in one BI.

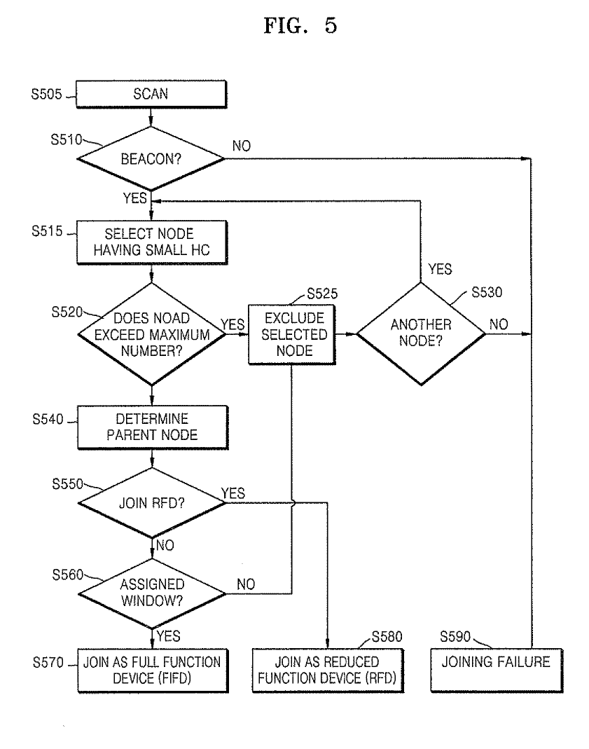

FIG. 3 is a conceptual diagram illustrating a method of generating windows according to another embodiment of the present invention.

Referring to FIG. 3, when only one channel is used, BO=6, and SO=3, windows are generated so that 8 SDs can be scheduled in one BI.

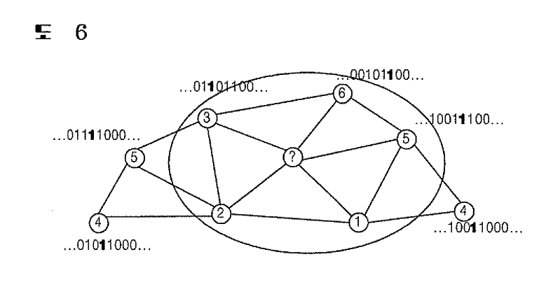

FIG. 4 is a conceptual diagram illustrating a method of generating windows according to another embodiment of the present invention.

Referring to FIG. 4, when 8 multi channels are used, BO=6, and SO=3, 8 windows per channel are generated.

In such a structure, a bit vector is expressed as follows in order to show windows of each channel.

| | |
|---|---|
| CH1-WV | {11, 12, 13, 14, 15, 16, 17, 18} |
| CH2-WV | {21, 22, 23, 24, 25, 26, 27, 28} |
| CH3-WV | {31, 32, 33, 34, 35, 36, 37, 38} |
| CH4-WV | {41, 42, 43, 44, 45, 46, 47, 48} |
| CH5-WV | {51, 52, 53, 54, 55, 56, 57, 58} |
| CH6-WV | {61, 62, 63, 64, 65, 66, 67, 68} |
| CH7-WV | {71, 72, 73, 74, 75, 76, 77, 78} |
| CH8-WV | {81, 82, 83, 84, 85, 86, 87, 88} |

When expression of the bit vector is generalized according to the number of channels (1≦k≦n) and the number of windows (1≦j≦m) in Multi-k CH_WV, the bit vector is expressed as follows.

| | |
|---|---|
| CH1-WV | {11, 12, . . . , 1j, . . . , 1m} |
| CH2-WV | {21, 22, . . . , 2j, . . . , 2m} |
| . . . | . . . |
| CHk-WV | {k1, k2, . . ., kj, . . . , km} |
| . . . | . . . |
| CHn-WV | {n1, n2, . . . , nj, . . . , nm} |

Each bit is assigned with an address, which is a pair (kj) of a channel and window, and regarding a bit value that can be assigned to each element of a window vector of each channel, when the window with the address belongs to the following two cases, the bit value corresponding to the window with the address is 1, and when the address is not occupied or the window with the address does not belong to the following two cases, the bit value corresponding to the window with the address is 0.

In the case of My channel Window # (MCW#) which the beacon transmitting node has control power over, MCW#t can be directly recognized by other nodes through beacon observation.

In the case of a window that is determined to be occupied by a node (neighboring node) located in a domain that can be reached by a wireless signal of the beacon transmitting node,

Elements of a network and functions thereof used in the present invention will now be described.

A PNC communicates with a coordinator, i.e. a child node, by differentiating a channel according to each window in one BI. The coordinator performs operations of a conventional coordinator described in IEEE 802.15.4 ZigBee, and when the coordinator joins a parent node, the coordinator uses a channel of the parent node. Here, the coordinator joins the parent node in such a way that its window schedule does not collide with a window schedule of the parent node and schedule of adjacent nodes using a corresponding channel. The window schedule of the coordinator is determined according to a method suggested in the present invention. A bridge coordinator is newly introduced in the present invention, and provides robust connectivity through multi paths by joining at least two parent nodes having different channels. A device conforms to the IEEE 802.15.4 ZigBee standard.

A process of a new node joining a network will now be described.

First, a node to be joined obtains network information (a beacon list) from adjacent coordinators by a scan, such as an energy detection (ED) scan or an active scan, like in the IEEE 802.15.4 ZigBee standard. Then, the node selects the most suitable parent node by using MCW# and multi-k CH-WV information included in a beacon that is periodically emitted from the adjacent coordinator, and occupies a channel # and a window # calculated through a corresponding channel and window selecting algorithm as its intrinsic channel and schedule. After joining the parent node, the node operates as a coordinator by transmitting a beacon for synchronizing devices that join the node and adjacent coordinators, according to an activating channel and the window schedule, i.e. during time corresponding to the window repeated at every BI.

Principles considered when a node joins a network are as follows.

First, the node joins a closest PNC. In other words, the node reduces network delay and the HC by joining a PNC having a small HC. Second, the node joins according to load balance so that the maximum NOAD is not exceeded. Third, even if the node desires to join as a coordinator, when the node cannot be assigned with a channel and a window, the node joins as a device.

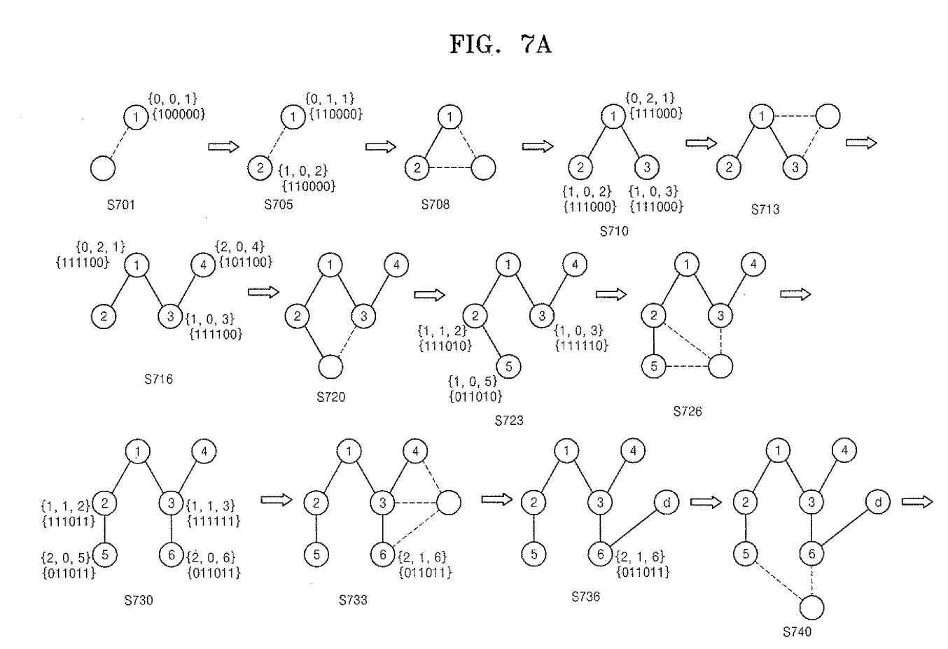

FIG. 5 is a flowchart illustrating a joining process of a node according to an embodiment of the present invention.

Referring to FIG. 5, a node that is to newly join a network performs scanning in operation S505 like in the IEEE 802.15.4 standard. Here, a beacon list is obtained by using beacons transmitted from adjacent coordinators. If no beacon is received, the node cannot join the network as in operation S590.

Nodes that are close to a PNC are able to observe a beacon from the PNC, and thus if possible, the node is determined to join a PNC in terms of scalability in operation S515. If it is determined that NOAD of a beacon received from the PNC does not exceed the maximum value in operation S520, a channel and window selecting algorithm is performed. Here, the PNC is determined as a parent node in operation S540. When the node is assigned with a channel and window (MCW) in operation S560, the node joins the PNC as a coordinator in operation 570. However, when the node is not assigned with a channel and window, the node becomes an orphan in operation S590 based on whether other coordinators exist around the PNC in operations S525 and S530. If another beacon is observed, the node joins the PNC as a coordinator according to the following processes.

A node that has the smallest HC from among HCs of other observed beacons is selected in operation S515, and if the NOAD of the node does not exceed the maximum value in operation S520, the node is determined as a parent node in operation S540. Accordingly, the channel and window selecting algorithm is performed in operation S560. If a window cannot be assigned, the node is excluded in operation S525, and it is determined whether there is another node in operation S530. If it is determined that there is another node, operation S515 is performed.

If a window is assigned, the node that is to newly join the network joins the parent node as a child coordinator having the value of the assigned window as its intrinsic schedule in operation S570. If a window is not assigned, the node joins the parent node as a device in operations S550 and S580, or becomes an orphan in operation S590.

When a node desires to join as a device, the node performs scanning in operation S505, and collects beacon information from adjacent coordinators in operation S510. Then, a coordinator that is determined to have the small HC in operation S515 and the small NOAD in operation S520 is selected as a parent coordinator in operation S540. Accordingly, the node joins the parent coordinator as a device in operations S550 and S580. If the parent coordinator cannot be found, the node becomes an orphan in operations S510, S530, and S590.

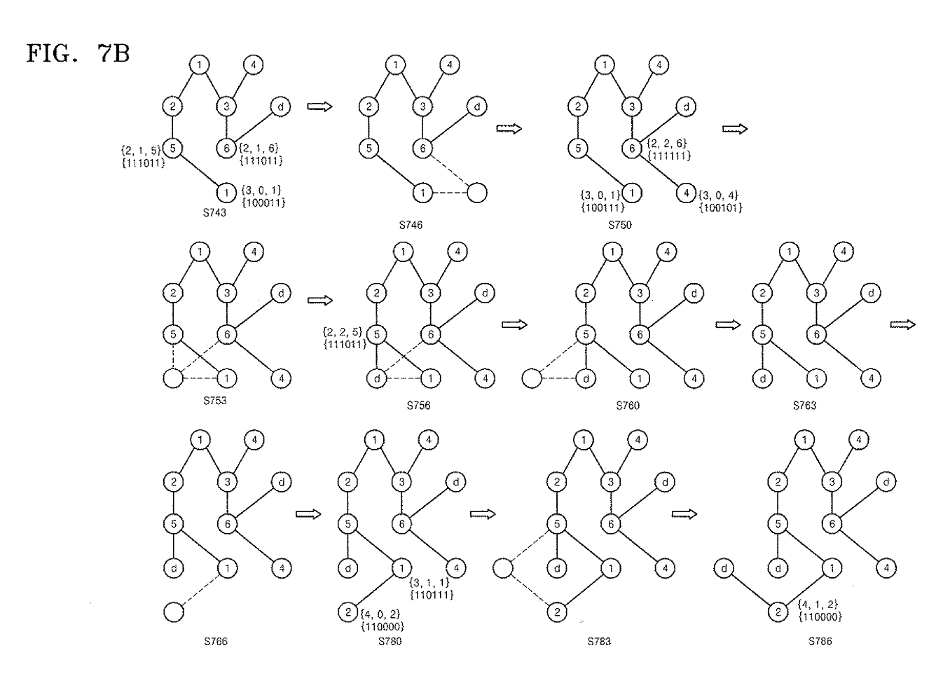

FIG. 6 is a conceptual diagram illustrating a window selecting algorithm in a single channel according to an embodiment of the present invention.

Referring to FIG. 6, the number of each node is a currently occupied window value. In a binary value expressed in a bit vector (CH-WV) about a channel and a window, 1s in bold represent windows occupied by the corresponding node and other 1s are windows occupied by neighboring coordinators within a wireless transmission range of the corresponding node.

When a new coordinator desires to join the node(?) or the network, a window may be selected as follows. When an OR operation is performed on CH-WVs of the observed beacons, a window indicated as 1 is a window occupied within 1 or 2 hops. Accordingly, one window may be randomly selected from among windows indicated as 0.

Single CH_WV operation

. . . 11011000 . . .
. . . 11101000 . . .
. . . 01101100 . . .
. . . 10011100 . . .
. . . 00101100 . . .
. . . 11111100 . . .
Free Window # = 7.8 Choice of 7

As a result, windows #7 and #8 are free, and when window #7 is selected, the node may join the network as a coordinator having the schedule of window #7.

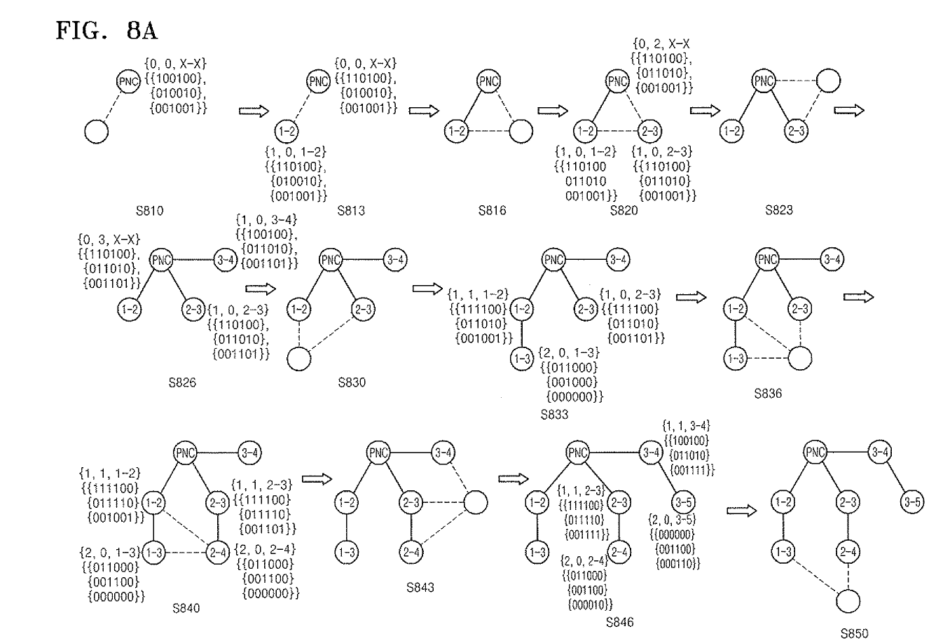

FIGS. 7A and 7B are a flowchart illustrating processes of constructing a cluster tree network in a single channel according to an embodiment of the present invention.

Referring to FIGS. 7A and 7B, a number written in each circle is a window assigned to each node, and a set of 3 numbers in each node respectively indicates HC, NOAD, and MCW. Also, a set of 6 numbers indicates windows occupied by a corresponding node and a neighboring node.

It is assumed that the number of assignable windows is 1-6 and the maximum value of NOAD is 2. In FIGS. 7A and 7B, a dotted line indicates a neighboring node, and a solid line indicates that a node is joined a network.

When only a PNC exists in the network, a HC of the PNC is 0 and the NOAD at this time is 0. Also, when a window assigned to the PNC is window 1, the PNC is {0,0,1}, {100000} in operation S701. Here, a new node desires to join the network. In this case, the PNC is the only neighboring node, and since the window 1 is occupied by the PNC, the node may select any one of windows from 2 through 6. In the current embodiment, the node selects window 2. Accordingly, the PNC has a child node, and the neighboring node occupies window 2, and thus the PNC is changed to {0,1,1}, {110000}, and the node is {1,0,2}, {110000} in operation S705.

In operation S708, another new node desires to join the network. From among the neighboring nodes, a node with a smaller HC is the PNC, and since the NOAD of the PNC does not exceed the maximum value, the PNC is determined as a parent node. Windows 1 and 2 are occupied by the neighboring nodes, and thus the new node selects window 3 from among unoccupied windows 3 through 6 as its own window. Accordingly, the new node is {1,0,3}, {111000}, and since the NOAD of the PNC is increased by 1 and window 3 is occupied by the new neighboring node, the PNC is {0,2,1}, {111000}. Also, since window 3 is occupied by the new neighboring node, the node that previously joined is {1,0,2}, {111000} in operation S710.

Following operations are performed in the same manner as the above operations S701 through S710. In other words, a new node selects a neighboring node, which has the smallest HC and whose NOAD does not exceed the maximum value, as a parent node. Here, if there is no node whose NOAD does not exceed the maximum value, the new node cannot join the network in operation S763. The new node selects a window from among windows that are not yet occupied by neighboring nodes. Here, if there is no window that can be selected, the new node joins the network as a device in operations S756 and S786.

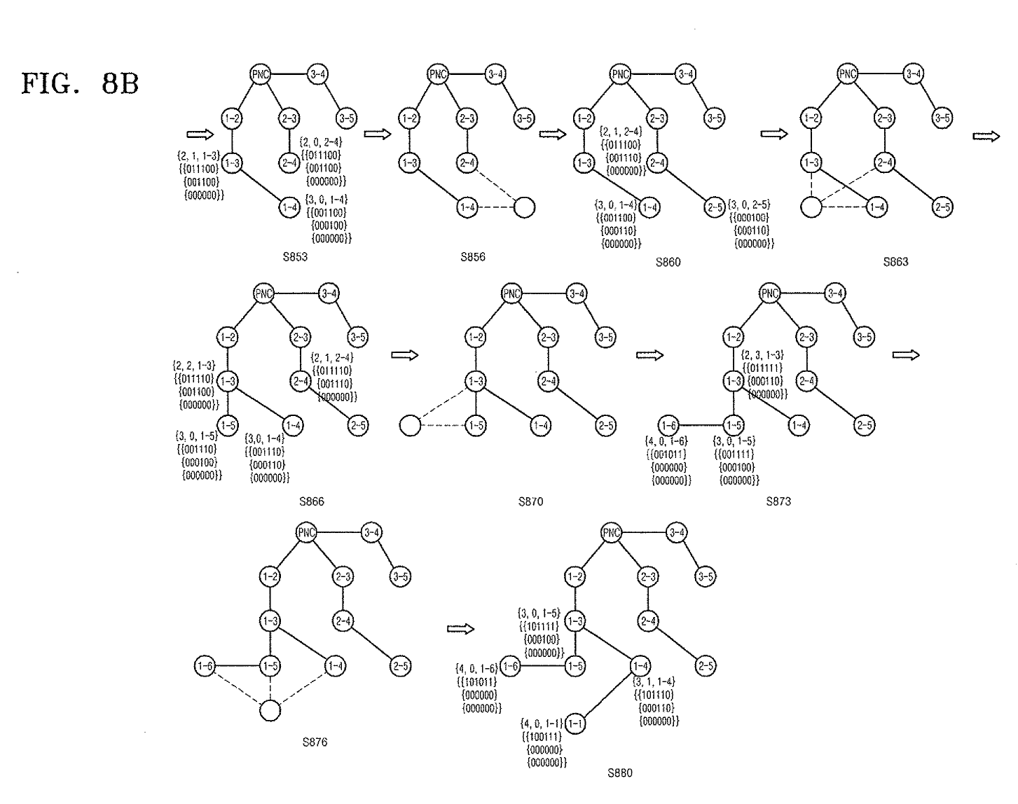

FIGS. 8A and 8B are a flowchart illustrating a process of constructing a cluster tree network in a multi channel according to an embodiment of the present invention.

Referring to FIGS. 8A and 8B, numbers indicated beside each node are basically equal to those of FIGS. 7A and 7B. However since the multi channel is used in the current embodiment, the first number in each circle indicates a channel used by the corresponding node, and the second number in each circle indicates that the node occupied a window that belongs to the channel corresponding to the front number. Also, a set of numbers indicating windows occupied by the corresponding node and neighboring nodes is indicated according to each channel.

In FIGS. 8A and 8B, it is assumed that there are 3 channels, 6 windows can be assigned to each channel, the maximum NOAD of a PNC is 6, and the maximum NOAD of other nodes is 2.

First, since the PNC communicates via a channel according to each time corresponding to each window, the PNC occupies windows 1-1, 2-2, 3-3, 4-1, 5-2, and 6-3. This is indicated as x-x in FIGS. 8A and 8B (operation S810). In operation S813, a new node desires to join the network by having the PNC as a neighboring node. Here, the NOAD of the PNC does not exceed the maximum value of 6, and thus the new node determines the PNC as the parent node, and assigns window 1-2 as its own node from among unoccupied nodes. Accordingly, a multi channel window vector of the PNC is {{110100}, {010010}, {001001}}.

Then, another new node desires to join the network in operation S816. The other new node determines the PNC, whose HC is small and whose NOAD does not exceed the maximum value, as a parent node from among neighboring nodes, and selects window 2-3 that is not yet occupied in operation S820. Accordingly, the NOAD of the PNC increases by 1, and thus the PNC is {0,2,x-x}, and the multi channel window vector of the PNC is {{110100}, {011010}, {001001}}. Regarding the other neighboring node, where window 1-2 is assigned as its own window, a multi channel window vector changes to {{110100}, {011010}, {001001}}.

Following operations are performed in the same manner as above. In other words, a new node selects a neighboring node, which has the smallest HC and whose NOAD does not exceed the maximum value, as a parent node. Here, if there is no node whose NOAD does not exceed the maximum value, the new node cannot join the network. The new node selects a window from among windows that are not yet occupied by neighboring nodes. Here, in order for the new node to communicate with the parent node by using the same channel, the new node has to select a window that belongs to the channel used by the parent node in operations S833, S840, S846, S853, S860, S866, S873, and S880.

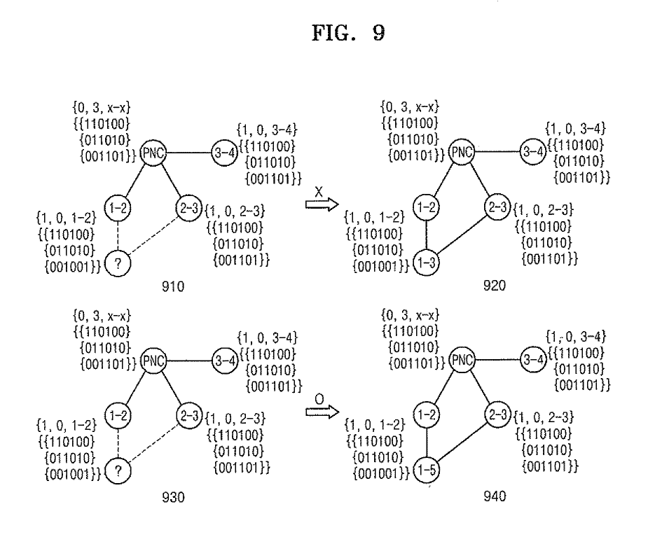

FIG. 9 is a conceptual diagram illustrating a method of assigning a window in a bridge coordinator according to an embodiment of the present invention.

Referring to FIG. 9, the meaning of each number is equal to that of FIG. 8. In operation 910, a new node desires to join a network from a domain having node 1-2 and node 2-3 as neighboring nodes. Here, since channel 1 and channel 2 are different from each other, the new node may determine any channel as the main link when the new node selects a parent node. However, when the new node operates after determining its schedule with window 3 in channel 1 and desires to change the schedule from the main link to a secondary link, the new node operates as a coordinator during its schedule of window 3, and operates as a child node during the schedule of window 3 in channel 2 of window 2-3 of the secondary link, and thus operation as the coordinator and the child node overlap. In other words, the schedules collide with each other, and thus there is no effect of a double link through a bridge coordinator in operation 920. Accordingly, while determining a schedule of a child coordinator, a following channel correction and window selecting algorithm is used.

When a beacon having a window of CHi-Wm and CHj-Wn is observed, and a node desires to be a bridge coordinator in operation 930 by having CHi-Wm as a primary parent node and CHj-Wn as a secondary (stand by) parent node, channel i is selected as the primary parent node, and a window is selected in such a way that the corresponding time does not overlap with the primary parent node and the secondary parent node. In this case, the node can operate as a child node via the main link with the primary parent node, and if the node cannot communicate via the main link, a secondary link may be used. Accordingly, the new node that is to be newly joined to the network selects window 5, whose time does not overlap with the primary parent node and the secondary parent node, in FIG. 9, and thus can operate as a bridge coordinator in operation 940.

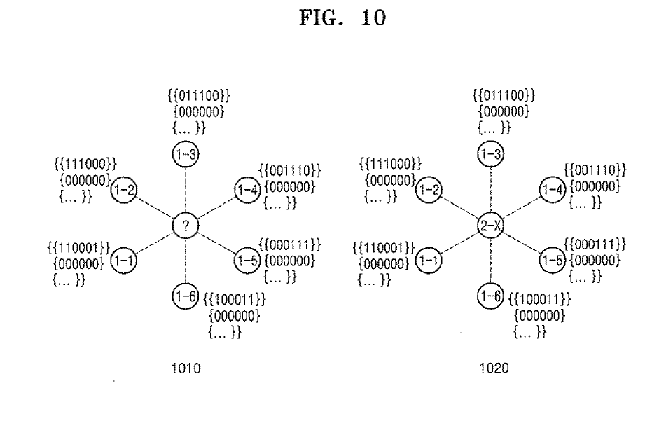

FIG. 10 is a conceptual diagram illustrating a method of assigning a window in a bridge coordinator according to another embodiment of the present invention.

Referring to FIG. 10, the meaning of each number is equal to that of FIG. 9. A network cannot be enlarged according to a conventional single channel IEEE 802.15.4 due to windows of neighboring nodes of a new node that is to newly join a network in operation 1010.

However by using the concept of the bridge coordinator in a multi channel according to the present invention, a function of connecting channels is introduced, and thus the network can be enlarged. Accordingly, scalability can be obtained.

The new node uses a different channel from the neighboring nodes, and thus can communicate even if time corresponding to its window overlaps with a certain neighboring node. In FIG. 10, windows of channel 1 are all occupied, and thus the new node may join the network by using a window that belongs to channel 2. Here, any window that belongs to channel 2 may be occupied.

The present invention is not only used in a single channel but also can be used in 16 channels in a 2.45 GHz band of the IEEE 802.15.4 standard. Accordingly, the present invention includes a channel assigning method for forming a cluster tree so that mutual interference does not occur in a multi channel, and a scheduling method between clusters that prevents beacon collision. In the present invention, network throughput is improved by using a multi channel and channels can be effectively assigned and scheduled. Consequently, clusters do not interfere with each other, and thus a cluster tree can be easily constructed. Accordingly, scalability is excellent and beacon collision does not occur, and thus network reliability increases.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A communication method of a wireless sensor network, which uses at least one channel and has a tree structure, the method comprising:
generating windows which a beacon interval is divided into, for each of the at least one channel;
selecting a window, that is not assigned to nodes that exist within a predetermined range from a certain node, from among the generated windows; and
the certain node communicating with a child node of the certain node by using a channel to which the selected window belongs during a time corresponding to the selected window.

2. The communication method of claim 1, wherein the selecting of a window comprises selecting a window, which is not assigned to the nodes and belongs to a channel used by a parent node of the certain node, from among the generated windows.

3. The communication method of claim 1, wherein the selecting of a window comprises selecting a window, which is not assigned to nodes that exist within a wireless transmission range of a certain node where a wireless signal of the certain node can directly reach, or within a wireless transmission range where a wireless signal of each of nodes existing in the wireless transmission range of the certain node can directly reach.

4. The communication method of claim 3, wherein the selecting of a window comprises:
generating a bit vector formed of bits corresponding to the windows with respect to each of nodes existing in the wireless transmission range of the certain node;
indicating only bits corresponding to windows assigned to a node having each bit vector and nodes in a wireless transmission range of the node having each bit vector as 1 in the bit vectors of the nodes existing in the wireless transmission range of the certain node;
calculating a logic sum of the indicated bit vectors of the nodes according to each bit; and
selecting one window from among windows corresponding to bits of the logical sum whose values are 0.

5. The communication method of claim 1, wherein in the generating of the windows, the length of each of the windows is a superframe duration.

6. The communication method of claim 1, further comprising:
selecting one of nodes, which are located in a domain where a wireless signal of the certain node can directly reach and whose joined devices do not exceed a permissible number, as a parent node of the certain node; and
communicating with the parent node by using a channel to which a window assigned to the parent node belongs during a time corresponding to the window assigned to the parent node.

7. The communication method of claim 6, further comprising selecting the parent node as a first parent node, and selecting a node that is not the parent node from among the nodes, which are located in the domain where a wireless signal of the certain node can directly reach and whose joined devices do not exceed the permissible number, as a second parent node of the certain node,
wherein the selecting of a window comprises selecting a window, which is not assigned to the nodes that exist within the predetermined range from the certain node and does not overlap a time corresponding to windows assigned to the first and second parent nodes, from among the generated windows, and
the communicating with the parent node comprises communicating with the first parent node by using the channel to which the window assigned to the first parent node belongs during the time corresponding to the window assigned to the first parent node, or communicating with the second parent node by using the channel to which the window assigned to the second parent node belongs during the time corresponding to the window assigned to the second parent node.

8. The communication method of claim 1, wherein the selecting of a window comprises selecting a window that is not assigned to the nodes, if windows that are not assigned to the nodes exist, and
the communicating with a child node comprises communicating with the child node by using the channel if windows that are not assigned to the nodes exist, and if windows that are not assigned to the nodes do not exist, joining the certain node to the wireless sensor network as a reduced function device (RFD).

9. A communication method in a gateway of a wireless sensor network, which uses at least one channel and has a tree structure, the communication method comprising:
generating windows which a beacon interval is divided into, for each of the at least one channel; and
assigning each of a part of or all of the generated windows to a child node, and communicating with the child node assigned with each window by using a channel to which each window belongs during a time corresponding to each assigned window.

10. A communication apparatus of a wireless sensor network, which uses at least one channel and has a tree structure, the communication apparatus comprising:
a window generator, which generates windows which a beacon interval is divided into, for each of the at least one channel;
a window selector, which selects a window, which is not assigned to nodes that exist within a predetermined range from a certain node, from among the generated windows; and
a communicator, through which the certain node communicates with a child node of the certain node by using a channel to which the selected window belongs during a time corresponding to the selected window.

11. The communication apparatus of claim 10, wherein the window selector selects a window, which is not assigned to the nodes and belongs to a channel used by a parent node of the certain node, from among the generated windows.

12. The communication apparatus of claim 10, wherein the window selector selects a window, which is not assigned to nodes that exist within a wireless transmission range of a certain node where a wireless signal of the certain node can directly reach, or within a wireless transmission range of each of nodes existing in the wireless transmission range of the certain node.

13. The communication apparatus of claim 12, wherein the window selector comprises:
a bit vector generator, which generates a bit vector formed of bits corresponding to the windows with respect to each of nodes existing in the wireless transmission range of the certain node;
a bit vector indicator, which indicates only bits corresponding to windows assigned to a node having each bit vector and nodes in a wireless transmission range of the node having each bit vector as 1 in the bit vectors of the nodes existing in the wireless transmission range of the certain node;
a calculator, which calculates a logic sum of the indicated bit vectors of the nodes according to each bit; and
a selector, which selects one window from among windows corresponding to bits of the logical sum whose values are 0.

14. The communication apparatus of claim 10, wherein in the window generator, the length of each of the windows is a superframe duration.

15. The communication apparatus of claim 10, further comprising:
a parent node selector, which selects one of nodes, which are located a domain where a wireless signal of the certain node can directly reach and whose joined devices do not exceed a permissible number, as a parent node of the certain node; and
a parent node communicator, which communicates with the parent node by using a channel to which a window assigned to the parent node belongs during a time corresponding to the window assigned to the parent node.

16. The communication apparatus of claim 15, further comprising a second parent node selector, which selects the parent node as a first parent node, and selects a node that is not the parent node from among the nodes, which are located in the domain where a wireless signal of the certain node can directly reach and whose joined devices do not exceed the permissible number, as a second parent node of the certain node,
wherein the window selector selects a window, which is not assigned to the nodes that exist within the predetermined range from the certain node and does not overlap with a time corresponding to windows assigned to the first and second parent nodes, from among the generated windows, and
the parent node communicator communicates with the first parent node by using the channel to which the window assigned to the first parent node belongs during the time corresponding to the window assigned to the first parent node, or communicates with the second parent node by using the channel to which the window assigned to the second parent node belongs during the time corresponding to the window assigned to the second parent node.

17. The communication method of claim 10, wherein the window selector selects a window that is not assigned to the nodes, if windows that are not assigned to the nodes exist, and
the child node communicator communicates with the child node by using the channel if the windows that are not assigned to the nodes exist, and if the windows that are not assigned to the nodes do not exist, joins the certain node to the wireless sensor network as reduced function device.

18. A gateway of a wireless sensor network, which uses at least one channel and has a tree structure, the gateway comprising:
a window generator, which generates windows which a beacon interval is divided into, for each of the at least one channel; and
a communicator, which assigns each of a part of or all of the generated windows to a child node, and communicates with the child node assigned with each window by using a channel to which each window belongs during time corresponding to each assigned window.
